(19) United States
(12) Patent Application Publication
(10) Pub. No.: US 2005/0235167 A1
(43) Pub. Date: Oct. 20, 2005

(54) Data streaming system with environment sensor

(76) Inventors: Harry Tiotantra, Singapore (SG); SzeChe Tan, Singapore (SG); WeiLoon Ng, Singapore (SG)

Correspondence Address: Seagate Technology LLC, 1280 Disc Drive, Shakopee, MN, 55379, US

(21) Appl. No.: 10/826,021

(22) Filed: Apr. 16, 2004

(51) Int. Cl. G06F 1/26

(52) U.S. Cl. 713/300

(57) ABSTRACT

A data streaming has a data storage device that provides an intermittent data stream to a buffer circuit. The data storage device generates a variable time-to-fill estimate as a function of a sensor output from an environment sensor. The buffer circuit provides a buffer data stream and a time-to-exhaust estimate. A comparator receives the time-to-fill and time-to-exhaust estimates and generates a comparator output. The comparator output couples to the data storage device to control energization of the data storage device.

### FIELD OF THE INVENTION

The present invention relates generally to data streaming systems, and more particularly but not by limitation to portable data streaming systems.

### BACKGROUND OF THE INVENTION

In audio and video playback applications where a data storage device (such as a hard disc drive) has a faster data transmission rate than an output device (such as a speaker or video display), data streaming can be used to conserve power. In particular, battery-powered devices such as portable music and video players use a memory buffer in an effort to ensure a continous stream of data to the output device. To ensure continuous data transmission, the memory buffer is cyclically refilled by the data storage device before the memory buffer exhausts its contents.

In such portable devices, environmental conditions such as shock, vibration, or temperature or humidity extremes can temporarily slow the transmission rate of the data storage device. When the data storage device is slowed, the device may not be able to refill the buffer before it is exhausted, and there is an undesirable break or interruption of playback for the user. Larger memories have been tried in buffers in an effort to avoid this problem, however, the use of larger memories drains down batteries quickly.

A method and apparatus are needed that will avoid breaks in playback due to changes in environmental conditions without incurring excessive power consumption. Embodiments of the present invention provide solutions to these and other problems, and offer other advantages over the prior art.

### SUMMARY OF THE INVENTION

A data streaming system is disclosed. The data streaming system comprises a data storage device that provides an intermittent data stream. The data storage device includes an environment sensor that generates a sensor output. The data storage device generates a variable time-to-fill estimate as a function of the sensor output.

The data streaming system also comprises a buffer circuit. The buffer circuit receives the intermittent data stream and provides a buffer data stream. The buffer circuit also generates a time-to-exhaust estimate.

The data streaming system also comprises a comparator. The comparator receives the time-to-fill and time-to-exhaust estimates and generates a comparator output. The comparator output couples to the data storage device to control energization of the data storage device.

Other features and benefits that characterize embodiments of the present invention will be apparent upon reading the following detailed description and review of the associated drawings.

### BRIEF DESCRIPTION OF THE DRAWINGS

FIG. 1 illustrates an oblique view of a disc drive.

FIG. 2 illustrates a first embodiment of a data streaming system.

FIG. 3 illustrates a timing diagram for a data streaming system.

FIG. 4 illustrates a second embodiment of a data streaming system.

FIG. 5 illustrates an embodiment of a time-to-fill estimate circuit.

FIG. 6 illustrates an embodiment of a time-to-exhaust estimate.

### DETAILED DESCRIPTION OF ILLUSTRATIVE EMBODIMENTS

In the embodiments described below, a data streaming system includes a data storage device that provides a variable time-to-fill estimate based on an environment sensor output. The data streaming system also includes a buffer circuit that provides time-to-exhaust estimate. A comparator compares the time-to-fill estimate with the time-to-exhaust estimate and provides a comparator output that controls energization of the data storage device. The energization is cyclical and varies based on environmental conditions to avoid breaks in playback and to provide continuous playback for the user without excessive power consumption.

Instead of allocating a fixed time before the buffer runs out of media data before refilling it, the disclosed arrangement provides performance prediction to ensure continuous playback and low power consumption. The storage device estimates or predicts how fast it will be able to deliver the data requested by the buffer circuit based on environmental conditions. The buffer circuit estimates or predicts how much time will elapse before it is exhausted. The comparator uses the information to energize the storage device to refill the buffer.

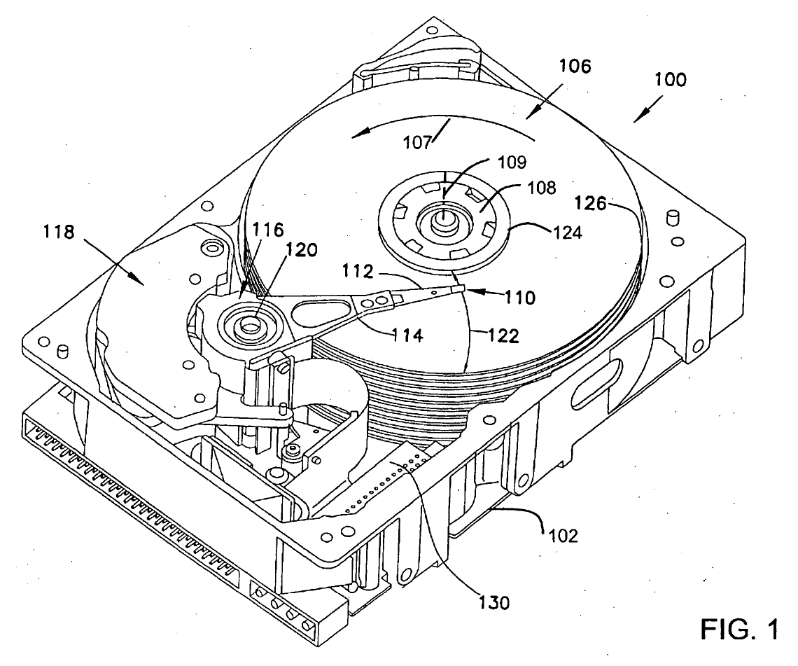

In a portable MP3 player example, the player can query the performance expectation of the hard disk drive as much as 30 seconds before the music buffer runs out. If this player is exposed to jogging condition, the shock sensor in the hard disk drive can allow the drive to estimate that it will take 20 seconds instead of 5 seconds to fulfill the requested data. This allows the player to issue the buffer refill request as early as 30 seconds instead of the original designed time of 10 seconds. Similarly in car audio applications, the hard disk drive may be exposed to very high operating temperatures so that it will take longer than 10 seconds to refill the music buffer. This performance estimation command will allow a host computer to provide more time for the hard disk drive to fulfill its request to refill a buffer. Various examples are described below in connection with FIGS. 1-6.

FIG. 1 is an oblique view of a disc drive 100 in which embodiments of the present invention are useful. Disc drive 100 includes a housing with a base 102 and a top cover (not shown). Disc drive 100 further includes a disc pack 106, which is mounted on a spindle motor (not shown) by a disc clamp 108. Disc pack 106 includes a plurality of individual discs, which are mounted for co-rotation in a direction indicated by arrow 107 about central axis 109. Each disc surface has an associated disc head slider 110 which is mounted to disc drive 100 for communication with the disc surface. In the example shown in FIG. 1, sliders 110 are supported by suspensions 112 which are in turn attached to track accessing arms 114 of an actuator 116. The actuator shown in FIG. 1 is of the type known as a rotary moving coil actuator and includes a voice coil motor (VCM), shown generally at 118. Voice coil motor 118 rotates actuator 116 with its attached heads 110 about a pivot shaft 120 to position heads 110 over a desired data track along an arcuate path 122 between a disc inner diameter 124 and a disc outer diameter 126. Voice coil motor 118 is driven by servo electronics 130 based on signals generated by heads 110 and a host computer (not shown).

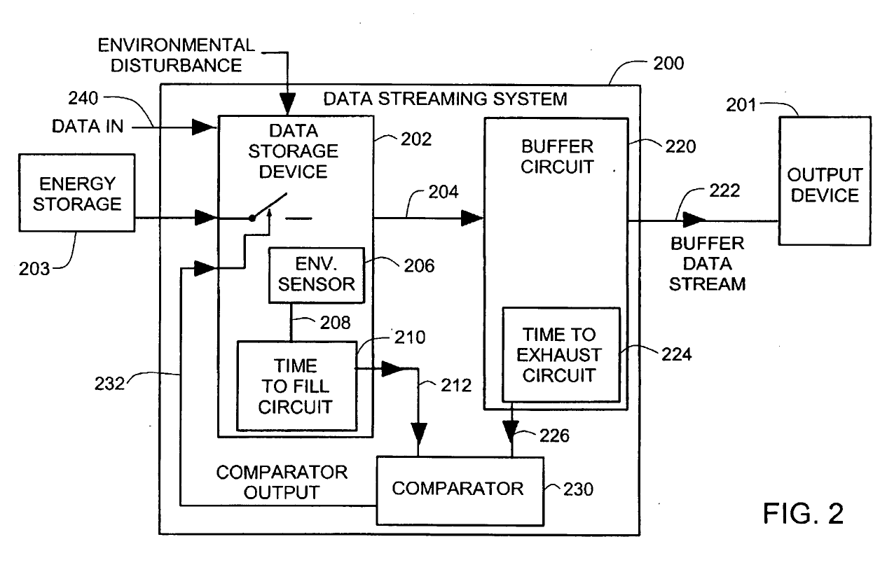

FIG. 2 illustrates a first embodiment of a data streaming system 200. The data streaming system 200 comprises a data storage device 202. The data streaming system 200 typically provides a video or audio data stream 222 to an output device 201 that reproduces continuous video or audio for a user. The data storage device 202 is typically a hard disc drive that, under ideal environmental conditions, is capable of providing data at a higher rate than is needed by the output device 201 and that can be operated intermittently (cyclically) to avoid rapid depletion of electrical energy from an electrical energy storage device 203, such as a battery.

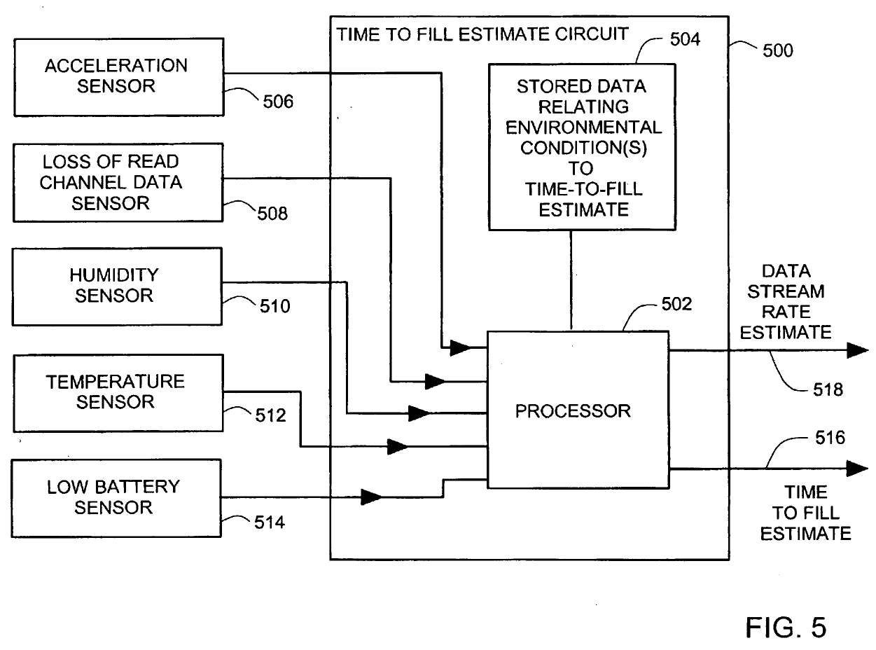

The data storage device 202 provides an intermittent data stream 204. The data storage device 202 includes one or more environment sensors 206 that sense an environmental condition of the data storage device 202 and that couple one or more environmental sensor outputs 208 to a time-to-fill estimating circuit 210. The time-to-fill estimating circuit 210 generates a variable time-to-fill estimate 212 as a function of the environmental sensor output 208. The time-to-fill estimate 212 comprises a performance predictor for a maximum rate at which the data storage device 202 is capable of delivering data under current environmental conditions. The environmental sensors 206 and the time-to-fill estimating circuit 210 are described in more detail below by way of an example illustrated in FIG. 5.

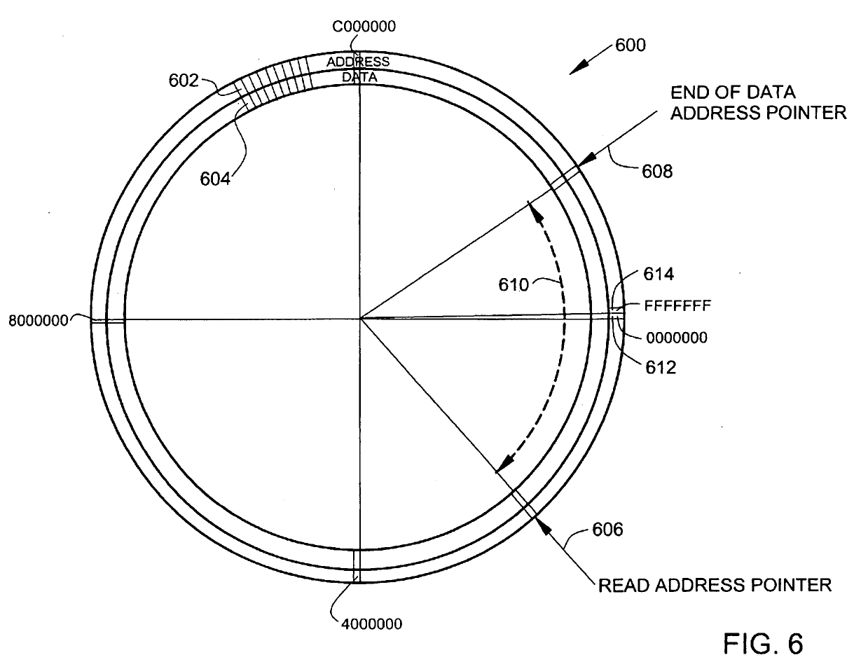

The data streaming system 200 also comprises a buffer circuit 220. The buffer circuit 220 receives the intermittent data stream 204 and provides the buffer data stream 222. The buffer circuit 220 includes a time-to-exhaust estimating circuit 224 that generates a time-to-exhaust estimate 226. The time-to-exhaust estimate 226 is described in more detail below in connection with an example illustrated in FIG. 6.

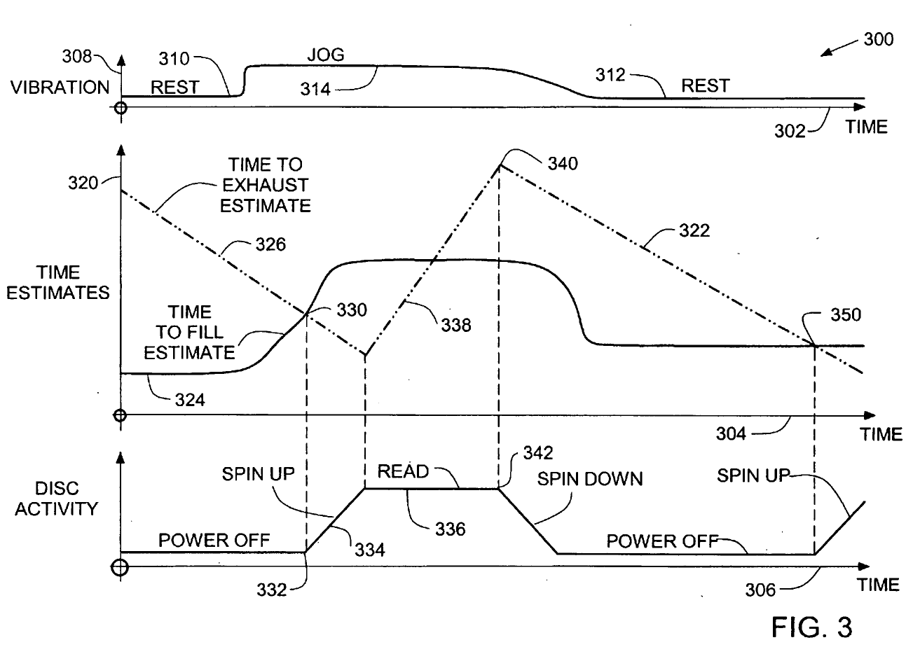

The data streaming system 200 also comprises a comparator 230. The comparator 230 receives the time-to-fill estimate 212 and the time-to-exhaust estimate 226. The comparator 230 generates a comparator output 232 that couples to the data storage device 202 to control energization of the data storage device 202 from the energy storage device 203. The operation of the comparator 230 is described in more detail below in connection with an example timing diagram illustrated in FIG. 3.

The data storage device 202 receives data on line 240 and stores the data. The data received on line 240 is typically a music file or a video file. At a later time, a user can playback the stored data through the output device 201 which can be an audio headset or a video display, or both. The data storage device 202 is operated intermittently at a high data rate during playback to quickly fill up the buffer circuit 220 with a portion of the file being played back, and then shut off by comparator output 232 to conserve energy. In a preferred arrangement, the comparator output 232 is shut off when the buffer circuit 220 is completely filled with data. The buffer circuit 220 provides the buffer data stream at a lower data rate to the output device 201. The operation of the data storage device 202 is cyclical. The data storage device 202 can be powered down or used for other tasks when there is adequate data in the buffer circuit 220 for uninterrupted playback.

FIG. 3 illustrates an example of a simplified timing diagram 300 for a data streaming system. The timing diagram 300 is described here with reference to the data streaming system 200 (FIG. 2), however, the timing shown can be applied to other embodiments of data streaming systems as well. The timing diagram 300 has horizontal axes 302, 304, 306 that represent time.

The timing diagram 300 has a vertical axis 308 that represents an exemplary environmental variable such as acceleration (vibration). The acceleration is low when the data storage device 200 is at rest during time intervals 310, 312. The acceleration is high when the data storage device is set in motion by an environmental disturbance, such as when a user carrying the data storage device 200 is jogging during time interval 314. The high acceleration during interval 314 causes a read head in the data storage device 200 to become intermittently misaligned with tracks to be read on a disc, for example, and the rate at which the data storage device can deliver data is slowed down due to the time needed to reestablish alignment between the read head and the desired tracks.

The timing diagram 300 has a vertical axis 320 that represents magnitudes of time estimates such as a time-to-exhaust estimate 322 (broken line) and a time to fill estimate 324 (solid line). When the acceleration rises to a high level at the start of interval 314, the time-to-fill estimate 324 increases because the drive is slowed down to a lower data rate by the high level of acceleration and the drive will take longer to transfer data due to the lower data rate.

As the buffer circuit 220 transfers data out to the output device 201, the time-to-exhaust estimate goes down as illustrated at 326. When the time-to-exhaust estimate 322 drops down to the same level as the time-to-fill estimate at crossover point 330, then the comparator output turns the data storage device 202 ON at 332. The data storage device 202 spins up to its operating speed at 334, and data is read from the data storage device at 336, refilling the buffer circuit 220 with data. As the buffer circuit 220 refills with data, the time-to-exhaust estimate increases at 338. In a preferred arrangement, once the data storage device 202 is energized, it is allowed to run until the buffer circuit 220 is filled with data. When the buffer circuit 220 is full again at 340, the data storage device shuts off at 342. The data storage device 202 then waits for the next crossover point 350 of time-to-exhaust estimate 322 and time-to-fill estimate 324 to reenergize the data storage device. The data storage device 202 is de-energized from 340 to 350 in FIG. 3. The energization of the data storage device 202 is intermittent, and the data provided at 204 is also intermittent. The timing of the energization of data storage device 202 is variable and dependent on environmental factors that affect the data rate of the data storage device 202 and that are sensed by the environmental sensor 206.

The control of the energization by the comparator output 232 prevents exhausting of data stored in the buffer circuit 220. The intermittent data stream 204 has a first data transmission rate (while data is being sent), and the buffer data stream 222 has a second data transmission rate that is slower than the first data transmission rate. The intermittent data stream 204 refills the buffer circuit 220 before the buffer circuit 220 is depleted of data, so that the buffer data stream 222 is a continuous data stream, or a stream that is fast enough to supply the data needs of the output device 201. The energization cycles on and off to reduce energy consumption in the data streaming system 200.

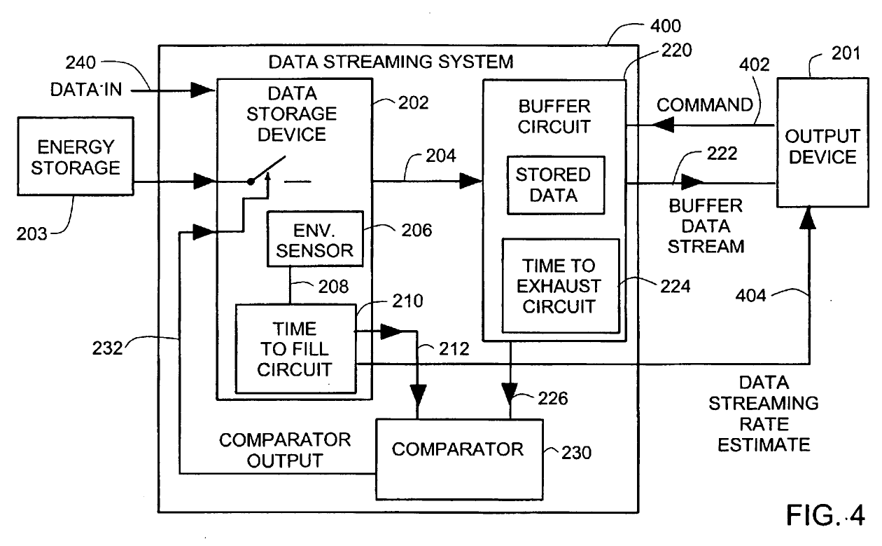

FIG. 4 illustrates a second embodiment of a data streaming system 400. Reference numbers used in FIG. 4 that are the same as reference numbers used in FIG. 2 identify the same or similar features.

In FIG. 4, the buffer circuit 220 received a command 402 from the output device 201. The command 402 indicates when the output device 201 is ready to receive more data from the buffer circuit 220. The buffer data stream 222 has a bit rate that is controlled by the command 402 received from an output device 201.

Also in FIG. 4, the time-to-fill circuit 210 further comprises a data streaming rate estimate output 404 that is couplable to the output device 201. The estimate output 404 preferably represents an average data rate for the data storage system 202 under current environmental conditions. The data streaming rate estimate is variable and has an inverse relationship to the time-to-fill estimate. The output device 201 can adjust its operation to adjust for low data streaming rates during environmental disturbances. A typical adjustment for the output device is to skip some video display updates during the environmental disturbance or to temporarily silence an audio output during the environmental disturbance, or both. In other respects, the data streaming system 400 in FIG. 4 is substantially similar to the data streaming system 200 in FIG. 2.

FIG. 5 illustrates an embodiment of a time-to-fill estimate circuit 500. The circuit 500 comprises a processor 502 coupled to stored data 504. The stored data 504 relates environmental conditions to time-to-fill estimates the stored data 504 is developed based on observed characteristics of a model data storage device during testing. The processor 502 receives environmental sensor outputs from one or more environmental sensors. As illustrated, the environmental sensors can include an acceleration sensor 506, a loss-of-read-channel-data sensor 508, a humidity sensor 510, a temperature sensor 512, a low battery sensor 514 or other sensor which senses an environmental condition that affects the data rate of the disc drive. The processor 502 generates a time-to-fill estimate 516. In a preferred arrangement, the processor 502 also generates a data streaming rate estimate 518. In one preferred arrangement, only a single sensor, the acceleration sensor 506, is used.

FIG. 6 illustrates computations in an exemplary time-to-exhaust circuit. In FIG. 6, data words 604 are stored in a buffer circuit (such as buffer circuit 220 in FIG. 2) in a range of buffer addresses 602 that range from a low address 612 (for example 0000000 hexadecimal) to high address 614 (for example FFFFFFF hexadecimal). The range from 0000000 to FFFFFFF is exemplary, and other size of buffers and ranges of buffer addresses can be used. For each buffer address 602, there is a corresponding data word 604 stored in the buffer. For convenience in describing the computations, the addresses 602 and data 604 are graphically illustrated in a circle 600. The circle 600 illustrates that the addresses 602 are in a continuous endless address loop and that the low address 612 mathematically follows the high address 614 when a processor (not illustrated) counts up or increments through buffer addresses 602. When the high address 614 (for example FFFFFFF) is incremented by 1, the processor discards or adjusts a “carry out” from the address range so that the next address is the low address (for example 0000000). The circle 600 bears a superficial similarity to a storage disc, but does not represent a storage disc. The buffer memory itself is stored in random access memory (RAM) that is typically arranged in one or more rectangular arrays on an integrated circuit substrate.

A processor (not illustrated) in the buffer circuit maintains a read address pointer 606 which points to an address of the next data word to be read and provided to a buffer data stream (such as buffer data stream 222 in FIG. 2). After a data word is read and provided to the buffer data stream, then the read address pointer 606 is incremented by 1 and moves to the next higher address. When the read address pointer 606 points to a high address 614, and is incremented by 1, then the next higher address is the low address 612.

The processor in the buffer circuit also maintains an end-of-data address pointer 608 which points to an address of the last data word that has been provided by a data storage device (such as data storage device 202) and stored in the buffer circuit. When the end-of data address pointer 608 points to address FFFFFFF, and is incremented by 1 when an additional word of data is received, then the end-of-data pointer 608 moves to next higher address, which is 0000000.

The processor calculates a mathematical address difference 610 between the end-of-data address pointer 608 and the read address pointer 606. The mathematical address difference 610 represents the amount of data remaining in the buffer that has not been read yet. The processor multiples the address difference by a scale factor to generate a time-to-exhaust estimate (such as time to exhaust estimate 226 in FIG. 2.). In a preferred embodiment, the scale factor is selected to scale the time-to-exhaust estimate to be directly comparable to a time-to-fill estimate (such as time-to-fill estimate 212 in FIG. 2).

This performance estimation arrangement can provide metrics like sustained data streaming rate. This data streaming rate can be reduced if the device is exposed to shock, vibration or extreme temperatures. The value of this data streaming rate can be determined through data collection and experiments during the design and development of the device.

It is found that typical joggers incur an external shock of frequencies between 3 Hz to 5 Hz to the disk drive. This frequency is low enough for the drive firmware to recover from off-tracks and retry the read operations. However the read throughput of the drive falls drastically. Experiments done on a drive show that the sustained transfer rate can drop from 20 MB/sec to as low as 4 MB/sec. By allowing the compressed audio player to ask for an estimate of the read performance of the disk drive under jogging environment, the player will know that it should be requesting to refill its music buffer 50 seconds before its music buffer exhausts instead of 10 seconds. This performance prediction provides increased resistance to acceleration in jogging situations, and avoids unnecessary waste of energization when acceleration is not present, thereby increasing battery life. There are fewer spin up/down cycles of the data storage device which leads to longer battery life and increased reliability of the data storage device.

It will be understood by those skilled in the art that various circuit functions described in the embodiments can be realized in a variety of combinations of hardware, firmware or software depending on the applications. It will also be understood by those skilled in the art that feature described in one embodiment may be appropriately applied to other embodiments.

In summary, a data streaming system (such as 200) is disclosed. The data streaming system comprises a data storage device (such as 202) that provides an intermittent data stream (such as 204). The data storage device includes an environment sensor (such as 206) that generates a sensor output (such as 208). The data storage device generates a variable time-to-fill estimate (such as 212) as a function of the sensor output.

The data streaming system also comprises a buffer circuit (such as 220). The buffer circuit receives the intermittent data stream and provides a buffer data stream (such as 222). The buffer circuit also generates a time-to-exhaust estimate (such as 226).

The data streaming system also comprises a comparator (such as 230). The comparator receives the time-to-fill and time-to-exhaust estimates and generates a comparator output (such as 232). The comparator output couples to the data storage device to control energization of the data storage device.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the media streaming system while maintaining substantially the same functionality without departing from the scope of the present invention. In addition, although a preferred embodiment described herein is directed to a disc drive system for audio or video applications, it will be appreciated by those skilled in the art that the teachings of the present invention can be applied to other data streaming applications, without departing from the scope of the present invention.

1. A data streaming system, comprising:
a data storage device providing an intermittent data stream; the data storage device also including an environment sensor and generating a variable time-to-fill estimate as a function of a sensor output;
a buffer circuit receiving the intermittent data stream, providing a buffer data stream, and generating a time-to-exhaust estimate; and
a comparator receiving the time-to-fill and time-to-exhaust estimates and generating a comparator output that couples to the data storage device to control energization of the data storage device.

2. The data streaming system of claim 1 wherein the control of the energization prevents exhausting of data stored in the buffer circuit.

3. The data streaming system of claim 1 wherein the intermittent data stream has a first data transmission rate, and the buffer data stream has a second data transmission rate that is slower than the first data transmission rate.

4. The data streaming system of claim 1 wherein the intermittent data stream refills the buffer circuit before the buffer circuit is depleted of data, so that the buffer data stream is a continuous data stream.

5. The data streaming system of claim 1 wherein the energization cycles on and off to reduce energy consumption in the data streaming system.

6. The data streaming system of claim 1 wherein the buffer data stream has a bit rate that is controllable by a command received from an output device.

7. The data streaming device of claim 1 wherein the data storage device further comprises a data streaming rate estimate output that is couplable to an output device.

8. The data streaming device of claim 1 wherein the environmental sensor comprises an acceleration sensor.

9. The data streaming device of claim 1 wherein the environmental sensor comprises a loss-of-read-channel-data sensor.

10. The data streaming device of claim 1 wherein the environmental sensor comprises a humidity sensor.

11. The data streaming device of claim 1 wherein the environmental sensor comprises a temperature sensor.

12. The data streaming device of claim 1 wherein the environmental sensor comprises a low battery sensor.

13. The data streaming device of claim 1 wherein the data storage device comprises a hard disc drive.

14. The data streaming device of claim 1 wherein the data storage device is mounted in a portable device subject to environmental shock.

15. A method of data streaming, comprising:
coupling an intermittent data stream from a data storage device to a buffer circuit that provides a buffer data stream;
coupling a variable time-to-fill estimate that is a function of an envirornental sensor output, and a buffer time-to-exhaust estimate to a comparator; and
controlling energization of the data storage device by generating a comparator output that couples to the data storage device.

16. The method of claim 15 further comprising:
preventing exhaustion of the buffer circuit by the controlling of energization.

17. The method of claim 15 further comprising:
transmitting data from the data storage device at a faster rate than transmission of data from the buffer circuit.

18. The method of claim 15 further comprising:
refilling the buffer circuit with data from the intermittent data stream before the buffer circuit is depleted of data.

19. The method of claim 15 further comprising:
reducing energy consumption in the data storage device by cycling the energization on and off.

20. The method of claim 15 further comprising:
controlling a bit rate of the buffer data stream by an output device.

21. The method of claim 15 further comprising:
the environmental sensor sensing an environmental variable selected from the group: acceleration, loss-of-read-channel-signal, humidity, temperature, low battery.

22. The method of claim 15 further comprising:
coupling a data streaming rate estimate output from the data storage device to an output device.

23. The method of claim 15 further comprising:
mounting the data storage device in a portable device subject to environmental shock.

24. A data streaming system, comprising:
a data storage device providing an intermittent data stream; the data storage device also including an environment sensor and generating a variable time-to-fill estimate as a function of a sensor output;
a buffer circuit receiving the intermittent data stream, providing a buffer data stream; and
comparator means for receiving the time-to-fill estimate and a time-to-exhaust estimate and for controlling energization of the data storage device.

25. The data streaming system of claim 24 wherein the controlling of energization prevents exhausting the buffer circuit.

26. The data streaming system of claim 24 wherein the controlling of energization reduces energy consumption on the data streaming system.

27. The data streaming device of claim 24 wherein the environmental sensor senses acceleration.
